(19) United States
(12) Patent Application Publication
(10) Pub. No.: US 2013/0151947 A1
(43) Pub. Date: Jun. 13, 2013

(54) INFORMATION PROCESSING APPARATUS, INFORMATION PROCESSING METHOD, AND STORAGE MEDIUM STORING PROGRAM

(71) Applicant: CANON KABUSHIKI KAISHA, Tokyo (JP)

(72) Inventor: Satoshi Okuma, Yokohama-shi (JP)

(73) Assignee: CANON KABUSHIKI KAISHA, Tokyo (JP)

(21) Appl. No.: 13/685,928

(22) Filed: Nov. 27, 2012

(30) Foreign Application Priority Data
Dec. 8, 2011 (JP) 2011-269395

(51) Int. Cl. G06F 17/22

(52) U.S. Cl. CPC G06F 17/2247
USPC 715/234

(57) ABSTRACT

An information processing apparatus sends a request of a document to a Web server, and receives the document sent from the Web server in response to the request. The information processing apparatus determines processing to be executed for the document received based on a query parameter designated when the request is sent, and executes the determined processing for the received document.

### BACKGROUND OF THE INVENTION

1. Field of the Invention

The present invention relates to an information processing apparatus, information processing method, and storage medium storing a program, which process a document received from a Web server.

2. Description of the Related Art

Conventionally, it is universally prevalent that an information processing apparatus such as an MFP including a Web browser function uses services provided by a Web server on a network by establishing a connection to the Web server. The Web server can provide services to the information processing apparatus by various Web applications such as a document server function.

The information processing apparatus acquires a document from the Web server, and can print and save the document by its print function and storage saving function. In this case, processing to be applied to the document by the information processing apparatus is selected by the user of the information processing apparatus. For example, when the user selects print processing, a print setting screen, which is originally built in the information processing apparatus, is displayed, and allows the user to make print settings.

Japanese Patent Laid-Open No. 2006-285461 describes a Web client apparatus which does not locally hold previously downloaded print data, downloads print data having the same print properties as those of the previous print data from the same server as the previous server under the same request conditions as the previous request condition, and prints the print data.

In a system including the aforementioned information processing apparatus such as an MFP and the Web server, the information processing apparatus is often used as a terminal in a workflow system. In this case, a Web browser is installed in the information processing apparatus as embedded software, so as to allow a Web application of the Web server to provide a user interface in that workflow. Then, the user can make operations according to the standardized user interface in the workflow system, and need not use a wide variety of operation screens for respective functions, which are originally built in the information processing apparatus, thus improving the convenience.

However, in such a system, when the user makes settings for a document acquired from the Web server on a setting screen which is originally built in the information processing apparatus, the settings which are not intended by a creator of the Web application of the Web server may often be made. After the user acquires a document from the Web server, and selects processing such as print processing on the Web browser, if a print setting screen is further displayed independently of the Web browser, the number of steps (man-hour) required for the settings is unwantedly increased. In general, when the Web server issues a print setting instruction of a document via a printer driver and the like, complicated processing is required, and imposes a heavy load on the creator of the Web application.

### SUMMARY OF THE INVENTION

An aspect of the present invention is to eliminate the above-mentioned problems with the conventional technology. The present invention provides an information processing apparatus, information processing method, and storage medium storing a program, which efficiently apply processing to a document received from a Web server.

The present invention in its first aspect provides an information processing apparatus comprising: a request unit configured to send a request of a document to a Web server; a receiving unit configured to receive the document sent from the Web server in response to the request of the request unit; a determination unit configured to determine processing to be executed for the document received by the receiving unit based on a query parameter designated when the request unit sends the request; and a processing unit configured to execute the processing determined by the determination unit for the document received by the receiving unit.

The present invention in its second aspect provides an information processing method comprising: sending a request of a document to a Web server; receiving the document sent from the Web server in response to the request; determining processing to be executed for the document received based on a query parameter designated when the request is sent; and executing the determined processing for the received document.

The present invention in its third aspect provides a computer-readable storage medium storing a program for controlling a computer to: send a request of a document to a Web server; receive the document sent from the Web server in response to the request; determine processing to be executed for the document received based on a query parameter designated when the request is sent; and execute the determined processing for the received document.

According to the present invention, processing can be efficiently applied to a document received from a Web server.

Further features of the present invention will become apparent from the following description of exemplary embodiments with reference to the attached drawings.

### BRIEF DESCRIPTION OF THE DRAWINGS

FIG. 1 is a view showing the overall configuration of a document processing system;

FIG. 2 is a block diagram showing the arrangement of an MFP;

FIG. 3 is a block diagram showing the arrangement of a Web server;

FIG. 4 is a block diagram for explaining the software configuration between the MFP and Web server;

FIG. 5 is a flowchart showing the sequence of processing between the Web browser and a Web application according to the first embodiment;

FIGS. 6A and 6B are views showing examples of screens displayed on an operation display unit of the MFP;

FIGS. 7A and 7B are views showing examples of screens displayed on the operation display unit of the MFP;

FIG. 8 is a flowchart showing the sequence of document processing on the Web browser side;

FIG. 9 is a flowchart showing the sequence of document processing on the Web browser side according to the second embodiment; and

FIG. 10 is a view showing an example of a screen displayed on the operation display unit of the MFP.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same parts, and a description thereof will not be repeated.

### First Embodiment

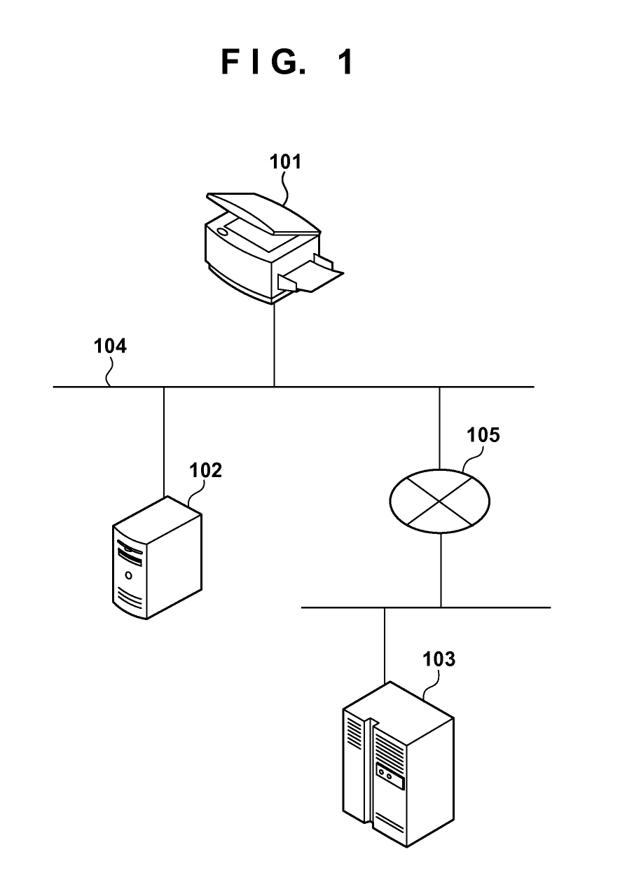

FIG. 1 is a view showing the overall configuration of a document processing system. In this system, an MFP 101 as an example of an information processing apparatus, and Web servers 102 and 103 are connected via networks such as a LAN 104 and the Internet 105 to be able to communicate with each other. The MFP 101 is a so-called Multifunction Peripheral. The MFP 101 has a copy function of optically reading (scanning) an image on a printing medium such as a paper sheet, and forming and printing an image on a printing medium based on the scan data. Also, the MFP 101 has a print function of printing a document on a printing medium based on document data received via the network. Furthermore, the MFP 101 incorporates a Web browser 400, can acquire contents such as PDF data and HTML data stored in the Web server 102 or 103, and can display the acquired contents on an operation display unit 211.

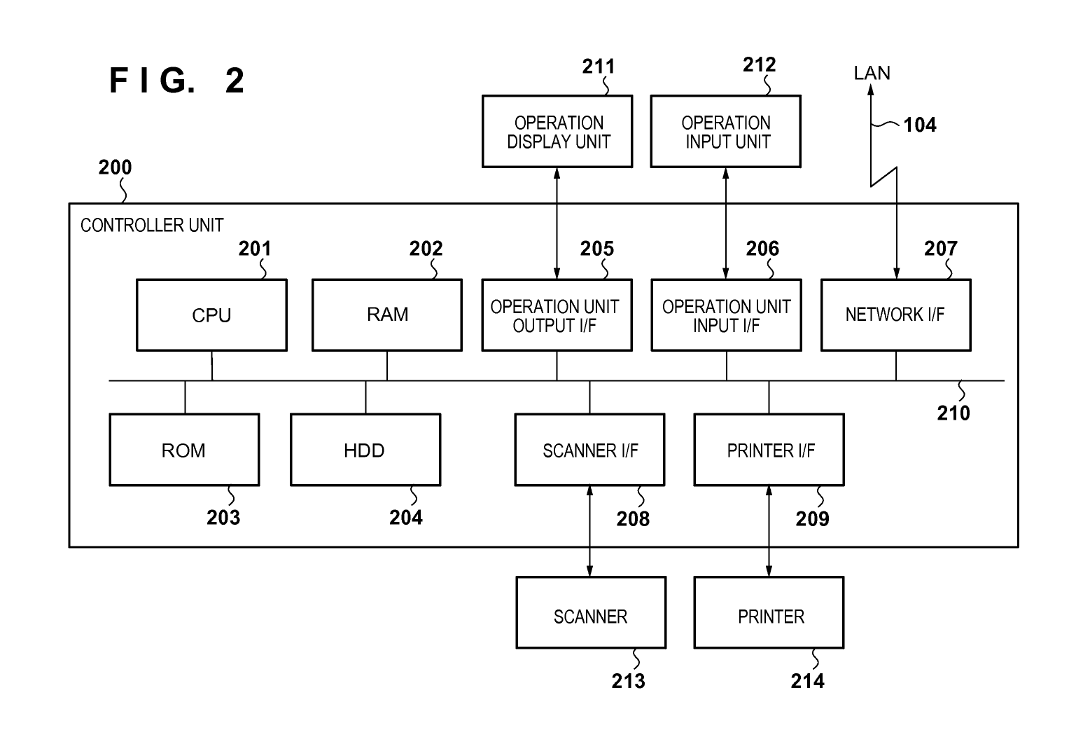

FIG. 2 is a block diagram showing the arrangement of the MFP 101. A scanner 213, printer 214, operation display unit 211, operation input unit 212, and LAN 104 are connected to a controller unit 200 of the MFP 101. A CPU 201 of the controller unit 200 executes various control programs to control respective units of the MFP 101. The CPU 201 boots up the MFP 101 based on a boot program stored in a ROM 203. Also, the CPU 201 reads out control programs stored in an HDD 204, and executes respective processes using a RAM 202 as a work area. The HDD 204 stores various control programs required to implement functions of the Web browser 400. Also, the HDD 204 stores scan data scanned by the scanner 213 and document data acquired from the external Web server 102 or 103 via a network I/F 207. The HDD 204 corresponds to an address database 411 which stores an address of the Web server 102 and the like. The address database 411 will be described later.

An operation unit output I/F 205 functions as an interface with the operation display unit 211, so as to output data to the operation display unit 211. An operation unit input I/F 206 functions as an interface with the operation input unit 212, so as to input data from the operation input unit 212. The network I/F 207 functions as an interface with the LAN 104, so as to input/output data from/to the LAN 104. A scanner I/F 208 functions as an interface with the scanner 213, so as to input/output image data and control data from/to the scanner 213. A printer I/F 209 functions as an interface with the printer 214, so as to output document data and control data to the printer 214. A system bus 210 interconnects the aforementioned units.

The operation input unit 212 includes input units such as a touch panel and hardware keys, and functions as an interface required to accept user instructions. The operation display unit 211 includes display devices such as an LCD and LEDs, and functions as an interface to be displayed for the user. The scanner 213 includes an image sensor such as a CCD, and acquires scan data by optically scanning a printing medium. The printer 214 prints scan data and document data on printing media such as paper sheets.

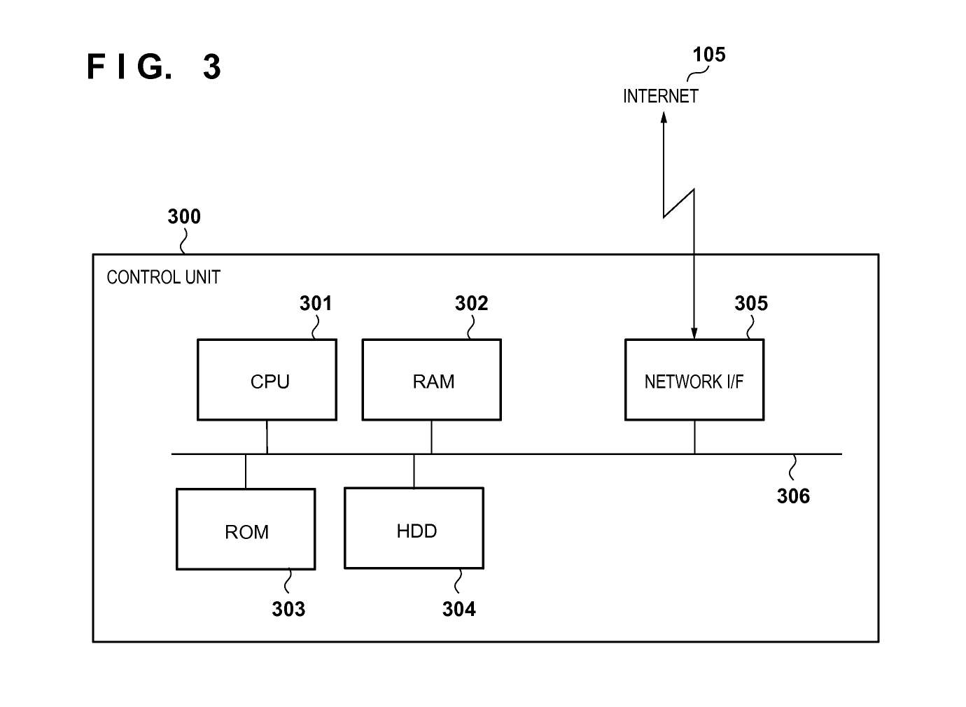

FIG. 3 is a block diagram showing the arrangement of the Web server 102. As the Web server 102, a general-purpose information processing apparatus such as a PC is used. Note that the Web server 103 also has the same arrangement as the Web server 102. The Web server 102 will be exemplified below. The Web server 102 has a control unit 300 which can establish a connection to the Internet 105. A CPU 301 of the control unit 300 executes various control programs to control the operations of the overall Web server 102. The CPU 301 reads out control programs stored in a ROM 303 and HDD 304, and executes respective processes using a RAM 302 as a work area. The HDD 304 stores various control programs required to implement functions of a Web application 421. Also, the HDD 304 stores screen contents and documents to be provided by the Web application 421, and corresponds to a content database 422 (to be described later). A network I/F 305 functions as an interface with the Internet 105, so as to input/output information from/to the Internet 105. A system bus 306 interconnects the aforementioned units.

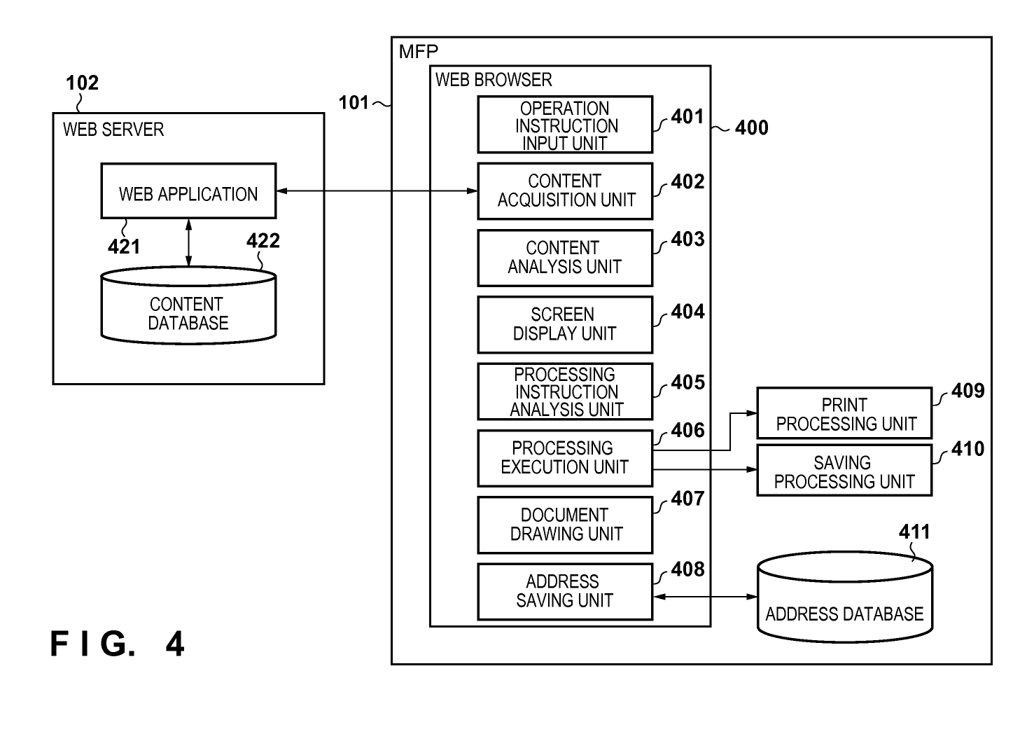

FIG. 4 is a block diagram for explaining the software configuration between the MFP 101 and Web server 102. Respective units from an operation instruction input unit 401 to a saving processing unit 410 are implemented when the CPU 201 of the MFP 101 reads out and executes control programs stored in the ROM 203 or HDD 204. Also, the Web application 421 is implemented when the CPU 301 of the Web server 102 reads out and executes control programs stored in the ROM 303 or HDD 304.

The MFP 101 has the Web browser 400, a print processing unit 409, and a saving processing unit 410. The Web browser 400 is embedded software installed in the MFP 101, and has functions represented by an operation instruction input unit 401 to an address saving unit 408.

The embedded software will be described below. For example, when the MFP 101 is used as a terminal in a workflow system, the embedded software is installed in the MFP 101 to allow the Web server 102 to provide a user interface. Then, the user can make operations according to the standardized user interface in that workflow system, and need not use a wide variety of operation screens for respective functions, which are originally built in the MFP 101, thus improving the convenience.

The operation instruction input unit 401 of the Web browser 400 accepts an input instruction from the user via the operation unit input I/F 206. For example, the operation instruction input unit 401 accepts user instructions such as an input of a URL address of the Web server 102 or 103 as a source of a content to be acquired, and a click instruction of a link on a displayed content. A content acquisition unit 402 communicates with the Web server 102 via the network I/F 207. For example, the content acquisition unit 402 issues a content request to the Web server using an HTTP protocol and the like in response to a user instruction, and receives a content from the Web server 102 as a response to the request. A content analysis unit 403 analyzes the content acquired by the content acquisition unit 402, and generates a display screen to be displayed on the operation display unit 211. In this embodiment, the content includes, for example, structured language files such as HTML files and document data such as PDF files. An HTML file describes the substance of a display screen to be displayed on the operation display unit 211. Types of these contents are identified by an HTML header element called [Content-type]. The content analysis unit 403 identifies a content type with reference to that [Content-type].

A screen display unit 404 displays the screen generated by the content analysis unit 403 or a document drawing unit 407 on the operation display unit 211 via the operation unit output I/F 205. A processing instruction analysis unit 405 determines whether or not an instruction of each processing for a document received from the Web server 102 or 103 is designated, and analyzes an instruction substance when it determines that the instruction is designated. An instruction of each processing for a document is appended as a query parameter to a URL requested from the MFP 101. Or an instruction may often be appended to an HTML extension header or the like. The instruction substance includes a print instruction, display instruction, saving instruction of a document, or the like, and a print count, saving location, or the like is set for each instruction as the aforementioned query parameter.

A processing execution unit 406 executes processing for a document according to the instruction substance analyzed by the processing instruction analysis unit 405. The processing execution unit 406 issues a print instruction to the print processing unit 409, a saving instruction to the saving processing unit 410, a drawing instruction to the document drawing unit 407, and the like according to the instruction substance. Also, the processing execution unit 406 checks whether or not the designated processing is executable in the MFP 101. Upon reception of an instruction from the processing execution unit 406, the document drawing unit 407 generates a display screen required to display a document on the operation display unit 211. An address saving unit 408 prompts the user to input a URL address of the Web server 102 or 103 upon accepting a document processing instruction, and saves the input URL address in the address database 411. A URL address input operation will be described later in the second embodiment. The print processing unit 409 receives document data and print settings from the processing execution unit 406, and prints a document using the designated print settings via the printer I/F 209. The saving processing unit 410 receives document data and saving settings from the processing execution unit 406, and saves the document data at a designated location in the HDD 204.

The Web server 102 includes the Web application 421. The Web application 421 acquires and modifies a content from the content database 422 in response to a request from the Web browser 400, and sends the content to the MFP 101 as a response. The content database 422 stores HTML data, document data, and the like to be displayed on the operation display unit 211 by the Web browser 400 of the MFP 101.

[Processing Between Web Browser and Web Application]

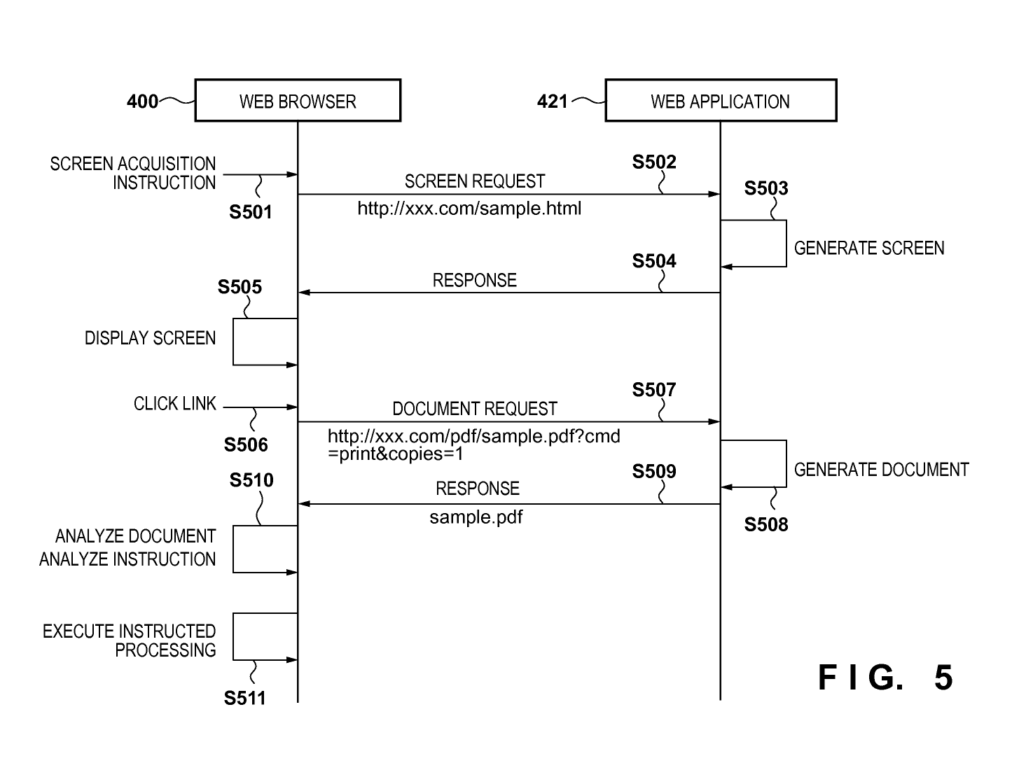

FIG. 5 is a flowchart showing the sequence of processing between the Web browser 400 of the MFP 101 and the Web application 421 of the Web serer 102 according to this embodiment. Respective processes on the Web browser 400 side in FIG. 5 are implemented when the CPU 201 of the MFP 101 executes control programs. Also, respective processes on the Web application 421 side in FIG. 5 are implemented when the CPU 301 of the Web server 102 executes control programs.

In step S501, the Web browser 400 of the MFP 101 accepts a content screen acquisition instruction from the user. This instruction is issued, for example, when the user designates a URL address registered as favorites or the like, or directly inputs a URL address. In this example, assume that the Web browser 400 accepts the screen acquisition instruction when the user inputs a URL address [http://xxx.com/sample.html]. In step S502, the Web browser 400 issues a content acquisition request to the URL address designated in step S501. In this example, the content acquisition unit 402 issues an acquisition request of a content [sample.html] to a server [xxx.com]. [Sample.html] is a drawing file (selection screen display file) required to display a selection display screen which displays a plurality of processes executable for a desired document so as to be selectable by the user.

In step S503, the Web application 421 of the Web server 102 corresponding to the address [xxx.com] acquires the content [sample.html] requested from the MFP 101 from the content database 422. In step S504, the Web application 421 sends the content [sample.html] requested in step S502 to the Web browser 400 of the MFP 101 as a response. In step S505, the content acquisition unit 402 of the Web browser 400 receives the content [sample.html]. Then, the content analysis unit 403 of the Web browser 400 generates a selection screen based on the received content [sample.html], and the screen display unit 404 displays that selection screen on the operation display unit 211.

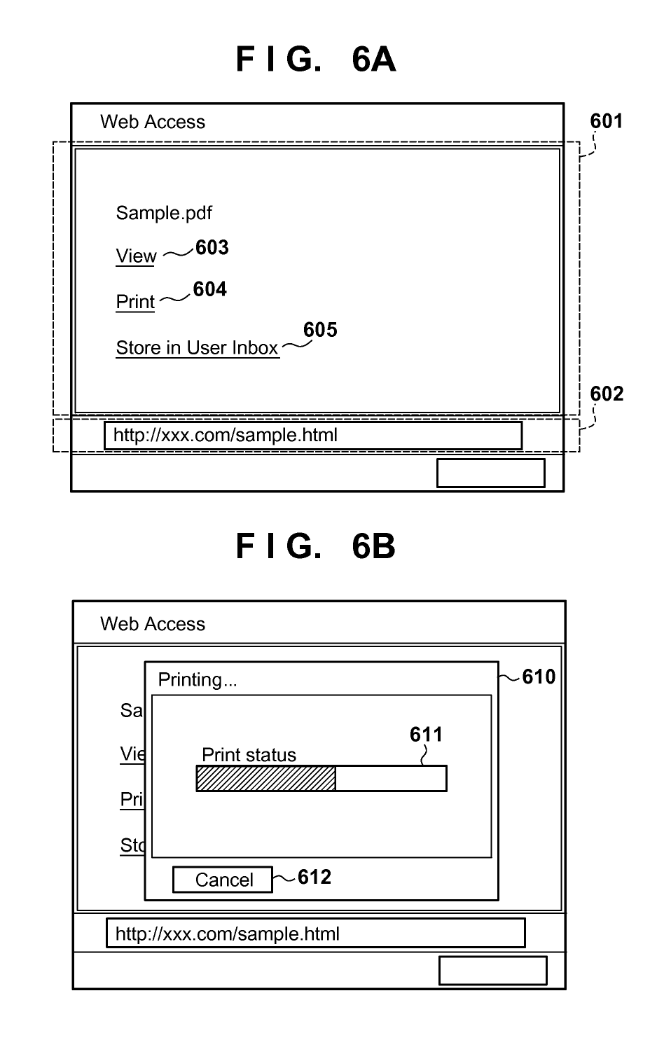

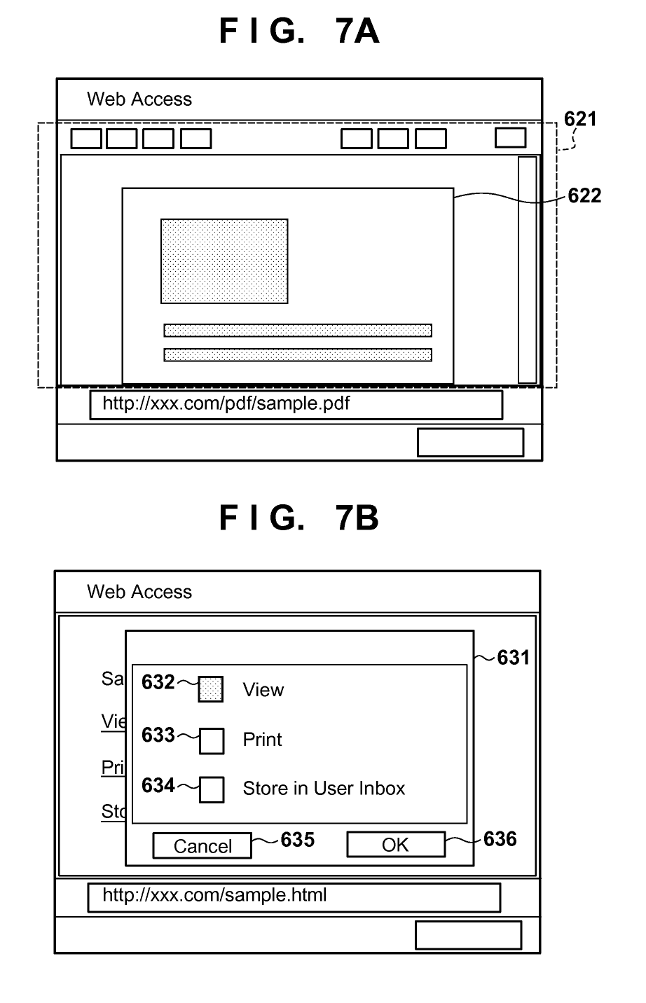

Screens to be displayed on the operation display unit 211 will be described below. FIGS. 6A, 6B, 7A, and 7B are views showing examples of screens to be displayed on the operation display unit 211. These screens are displayed on the operation display unit 211 via the operation unit output I/F 205 by the screen display unit 404 of the Web browser 400. FIG. 6A shows an example of the screen displayed in step S505. A content display area 601 displayed on the operation display unit 211 displays the substance of the acquired content, for example, [sample.html]. Also, an address display area 602 displays a URL address (position information) of the content displayed on the content display area 601, for example, [http://xxx.com/sample.html]. Links 603 to 605 are anchor texts set with links to other contents in the selection screen display file, and represents a plurality of processes executable for [Sample.pdf]. When the user selects one of these anchor texts on the selection screen, he or she can acquire a content linked with the selected anchor text.

A description of the content [sample.html] shown in FIG. 6A includes, for example, the following description.

```
  Sample.pdf<br><br>
  <a href=“http://xxx.com/pdf/sample.pdf?
  cmd=view”>View</a><br><br>
  <a href=“http://xxx.com/pdf/sample.pdf?
  cmd=print&copies=1”>Print</a><br><br>
  <a href=“http://xxx.com/pdf/sample.pdf?
  cmd=store&boxnum=10”>Store in User
Inbox</a><br><br>
```

Each individual anchor text is designated with an address of a content as a link destination by [href]. In this case, a PDF file [pdf/sample.pdf] is designated as the address of the link destination. However, different query parameters are designated to follow the address. In this case, a query parameter is, for example, [cmd=view], and represents processing designated for the PDF document [sample.pdf]. For example, [cmd=view] represents a view display instruction, [cmd=print] represents a print instruction, and [cmd=store] represents a storage instruction. The query parameter can designate various setting values of document processing such as a two-sided print designation in addition to the number of copies to be printed by joining instructions using [&]. In this embodiment, the Web application 421 of the Web server 102 generates the content which designates a link destination appended with the aforementioned query parameter in step S503. FIG. 6A shows only one type of the anchor text [Print] in association with print processing. For example, another anchor text [Print2] may be displayed. A description of [Sample.html] corresponding to that [Print2] may represent, for example, an instruction (to print two copies) different from [Print] as follows.

<a href=“http://xxx.com/pdf/sample.pdf?
cmd=print&copies=2”>Print</a><br><br>

Referring back to FIG. 5, after the screen is displayed in step S505, as shown in FIG. 6A, the user selects a desired anchor text on the screen shown in FIG. 6A by clicking it in step S506. In this case, assume that the user selects the anchor text of the link 604 in FIG. 6A. As for the link 604, [sample.html] includes the description [<a href=“http://xxx.com/pdf/sample.pdf? cmd=print&copies=1”>Print</a><br><br>]. In this case, in step S507, the content acquisition unit 402 of the Web browser 400 issues an acquisition request of a content based on the description [/pdf/sample.pdf?cmd=print&copies=1] to the Web server 102 as [xxx.com].

In step S508, the Web application 421 of the Web server 102 acquires the content requested from the MFP 101. For example, the Web application 421 acquires a document corresponding to [/pdf/sample.pdf] from the content database 422. Upon acquisition from the content database 422, the query parameter which represents a document processing instruction is ignored. In step S509, the Web application 421 sends the content [/pdf/sample.pdf] acquired from the content database 422 to the MFP 101 as a response.

In step S510, the Web browser 400 of the MFP 101 checks the type of the content [/pdf/sample.pdf] sent from the Web application 421 of the Web server 102. The content analysis unit 403 of the Web browser 400 checks with reference to [Content-type] of an http header of the document request in step S507 whether or not the content acquired in step S509 is that of a type which can be processed by the MFP 101. For example, if [Content-type] indicates a PDF file expressed by [application/pdf], the Web browser 400 determines that the content is of the type which can be processed by the MFP 101. In this case, when the document of the type which can be processed by the MFP 101 is determined, the processing instruction analysis unit 405 of the Web browser 400 checks whether or not document processing is designated for that document. This checking process is attained by seeing whether or not a query parameter which instructs the document processing is appended at the time of the content acquisition request in step S507. When the query parameter is appended, the processing instruction analysis unit 405 further detects a document processing instruction appended to the query parameter. For example, when [cmd=print] is appended as the query parameter, the processing instruction analysis unit 405 determines that a print execution instruction of the PDF document is designated. Then, the processing instruction analysis unit 405 also recognizes that [1 copy] is set as the number of copies to be printed when an instruction [copies=1] is appended.

When [cmd=view] is appended as the query parameter, the processing instruction analysis unit 405 determines that a screen display instruction of the document is designated. When [cmd=store&boxnum=10] is appended as the query parameter, the processing instruction analysis unit 405 determines that a storage instruction to a user box No. 10 of storage locations called user boxes in the HDD 204 is designated for the document. As described above, the content analysis unit 403 analyzes the instruction substance of the document processing based on the query parameter.

In step S511, the processing execution unit 406 of the Web browser 400 executes the document processing analyzed in step S510. For example, when [cmd=print&copies=1] is appended as the query parameter, the processing execution unit 406 instructs the print processing unit 409 to print one copy of the document received in step S509.

FIG. 6B is a view showing an example of a screen displayed on the operation display unit 211 in step S511. A print execution dialog 610 is displayed when print processing of the document by the MFP 101 is in progress. A progress bar 611 indicates a progress status of the print processing of the document. A cancel button 612 accepts a print cancel instruction of the document by the user. In case of this example, when the user selects the link 604 in FIG. 6A in step S506, the print processing of the document is executed, and the screen shown in FIG. 6B is displayed.

If the user selects the link 603 in step S506, a query parameter of a document display instruction is appended to issue an acquisition request of the content in step S507. In this case, the processing instruction analysis unit 405 determines in step S510 that the document display instruction is designated by the query parameter, and the processing execution unit 406 instructs, in step S511, the document drawing unit 407 to display the document received in step S509. As a result, the document drawing unit 407 displays the document on the content display area 601. FIG. 7A is a view showing an example of a screen displayed on the operation display unit 211 in step S511. The document is displayed as an image 622 on a document display area 621. The document display area 621 is the same area as the content display area 601 in FIG. 6A. In case of this example, when the user selects the link 603 in FIG. 6A in step S506, the document display processing is executed, and the screen shown in FIG. 7A is displayed.

If the processing instruction analysis unit 405 determines in step S510 that no document processing is designated for the document, the processing execution unit 406 inquires, in step S511, the user about processing to be applied to the document received in step S509. FIG. 7B is a view showing an example of a screen displayed when the processing instruction analysis unit 405 inquires the user about document processing in step S511. The screen shown in FIG. 7B is a dialog screen originally built in the MFP 101 unlike in FIGS. 6A, 6B, and 7A. A document processing inquiry dialog 631 displays choices of processes of the document received in step S509. A display instruction button 632, print button 633, and user box saving button 634 are respectively buttons used to accept selection of respective document processes. When the user presses a cancel button 635, he or she can instruct not to apply any processing to the document. When the user presses an OK button 636, he or she can settle the process selected using the buttons 632 to 634, and can instruct to apply that process to the document.

As described above, according to this embodiment, when the user of the MFP 101 selects a link of processing to be applied to the document on the screen shown in FIG. 6A, the MFP 101 checks whether or not that document can be processed by itself, and then executes the processing. That is, in this system, the user selects desired document processing on the screen shown in FIG. 6A. Therefore, unlike in the conventional system, a print setting screen of the document, which is originally built in the MFP 101, can be prevented from being displayed to execute document processing which is not intended by the creator of the Web application 421. As described in step S503, since the Web application 421 need only append each document processing as a query parameter, the MFP 101 need not be controlled via a printer driver or the like, thus simplifying the arrangement.

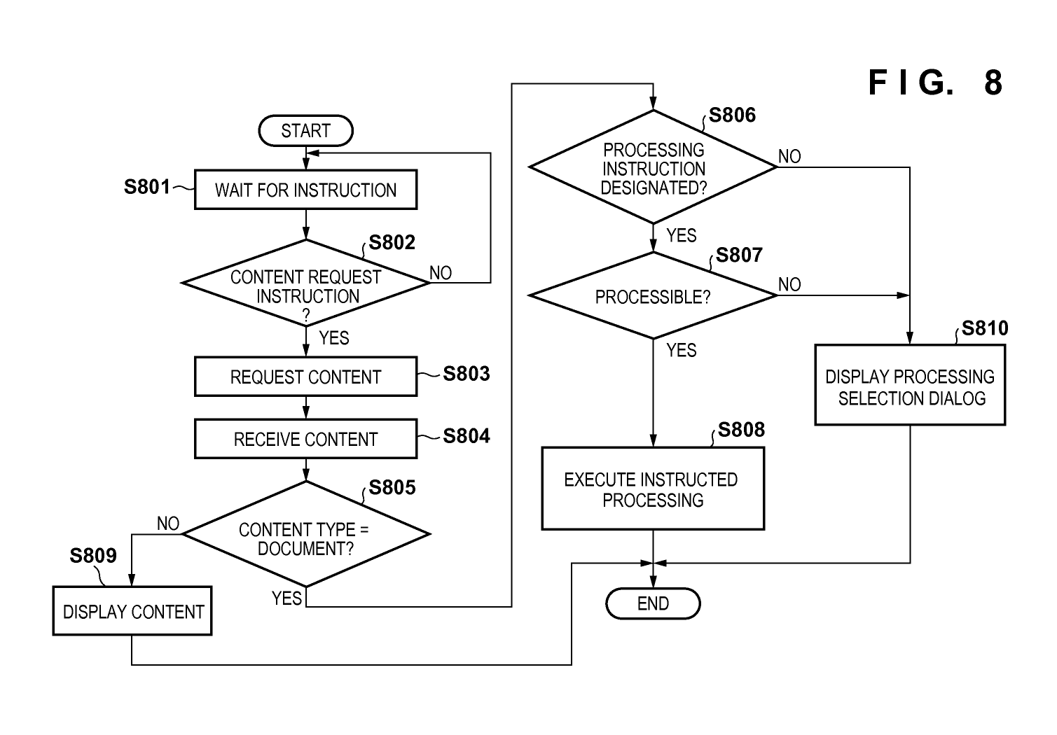

FIG. 8 is a flowchart showing the processes in step S506 and subsequent steps in FIG. 5 while being focused on the Web browser 400 side. The processes shown in FIG. 8 can be implemented when the CPU 201 of the MFP 101 executes control programs. In step S801, the Web browser 400 of the MFP 101 waits for a content acquisition instruction from the user. This step corresponds to step S506 in FIG. 5. The Web browser 400 checks in step S802 whether or not the user inputs the content acquisition instruction. For example, the operation instruction input unit 401 checks whether or not the content acquisition instruction is received by seeing whether or not selection by clicking on the screen shown in FIG. 6A is accepted from the user. If the operation instruction input unit 401 determines in step S802 that no content acquisition instruction is received, step S801 is repeated.

If the operation instruction input unit 401 determines in step S802 that the content acquisition instruction is received, the process advances to step S803. In step S803, the content acquisition unit 402 sends a content request to the designated URL address. This step corresponds to step S507 in FIG. 5. In step S804, the content acquisition unit 402 receives a content sent from the Web server 102 as a response. This step corresponds to step S509 in FIG. 5.

In step S805, the content analysis unit 403 analyzes the type of the content received in step S804 to check whether or not the content is a document of a type which can be processed by the MFP 101. If it is determined that the received content is not a document of a type which can be processed by the MFP 101, the content analysis unit 403 draws and generates a screen by analyzing the substance of the content in step S809. Then, the screen display unit 404 displays a screen on the operation display unit 211 based on the generated screen. In this case, the document of the type which cannot be processed by the MFP 101 includes, for example, an error screen. That is, although the MFP 101 requests a PDF file, when that PDF file is not available in the content database 422 of the Web server 102, the Web server 102 sends an HTML file which represents an error screen to the MFP 101 as a response, and that file is the document of the type which cannot be processed by the MFP 101. In this case, the error screen is displayed in step S809.

On the other hand, if it is determined in step S805 that the type of the received content is that which can be processed by the MFP 101, the processing instruction analysis unit 405 checks in step S806 whether or not a document processing instruction for the received document is designated. The processing instruction analysis unit 405 analyzes the URL address of the content request in step S803 corresponding to the content received in step S804 to check if a query parameter is appended. If it is determined that no query parameter is appended, the process advances to step S810. In step S810, the processing instruction analysis unit 405 displays a dialog which inquires the user about processing to be applied to the document. The dialog displayed in this case is the document processing inquiry dialog 631 shown in FIG. 7B. The processing instruction analysis unit 405 instructs the screen display unit 404 to generate a screen of the document processing inquiry dialog 631.

If it is determined in step S806 that the document processing instruction for the received document is designated, the process advances to step S807. The processing instruction analysis unit 405 checks in step S807 whether or not that document processing instruction is a valid instruction for the MFP 101 and can be processed by the MFP 101. For example, an instruction which is valid for the MFP 101 and can be processed by the MFP 101 is that using the functions of the MFP 101. If it is determined that the instruction is not valid for the MFP 101 or it cannot be processed by the MFP 101, the process advances to step S810. On the document processing inquiry dialog 631 displayed in this case, only buttons corresponding to processes which can be processed by the MFP 101 of the buttons 632 to 634 may be displayed. In this case, if it is determined that none of the processes corresponding to the buttons 632 to 634 are executed, the processing instruction analysis unit 405 may display a message that advises accordingly on the document processing inquiry dialog 631. Also, in this case, even when the user presses the OK button 636, any processing is inhibited from being applied to the document.

If it is determined in step S807 that the instruction is valid for the MFP 101 and can be processed by the MFP 101, the processing execution unit 406 executes the document processing according to the instructed substance. For example, if the designated instruction is a print instruction for the document, the processing execution unit 406 instructs the print processing unit 409 to print the document. If the designated instruction is a display instruction of the document, the processing execution unit 406 instructs the document drawing unit 407 to draw a display screen of the document. On the other hand, if the designated instruction is a saving instruction of the document, the processing execution unit 406 instructs the saving processing unit 410 to save the document.

As described above, in this embodiment, according to an instruction based on the query parameter of the document link designated by the Web application 421 on the Web server 102, the Web browser 400 of the MFP 101 executes the document processing.

### Second Embodiment

The second embodiment will be described below. Note that the system configuration and the like are the same as those in the first embodiment. Differences from the first embodiment will be described below. In this embodiment, the Web browser 400 holds a predetermined server address. Then, when the Web browser 400 receives a document from a Web server, it checks whether or not that document is received from the Web server having an address which matches the predetermined server address. Only when it is determined that the document is received from the Web server having the address that matches the predetermined server address, document processing designated for that document is executed.

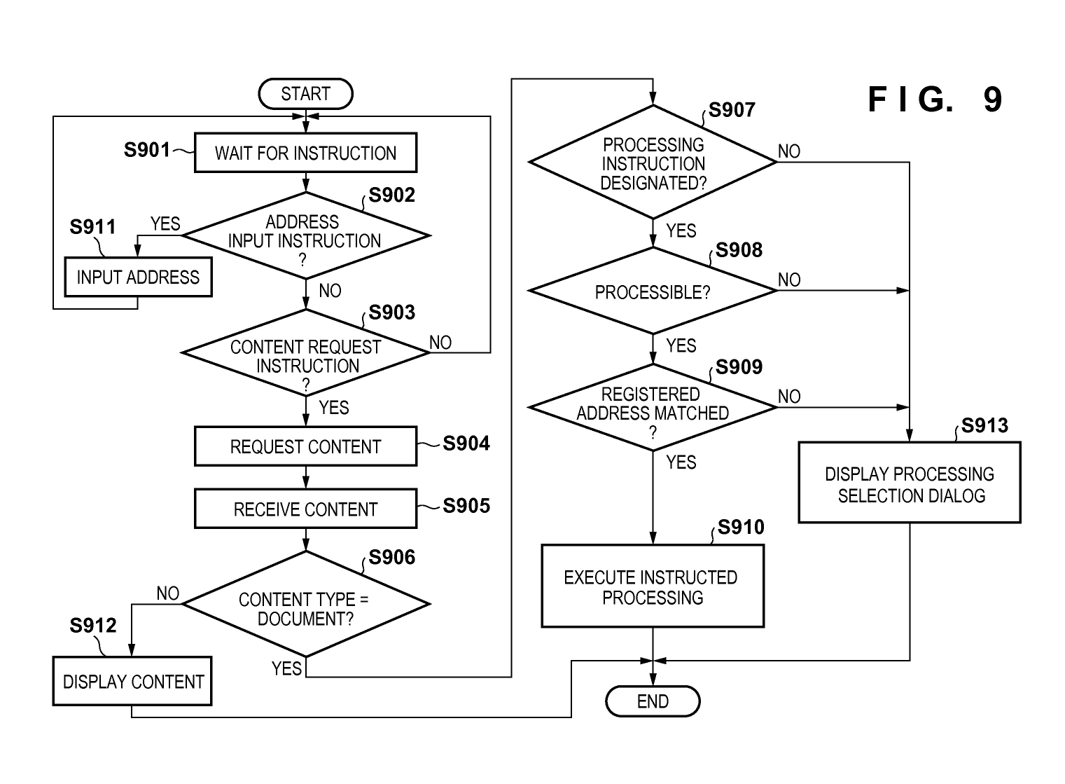

FIG. 9 is a flowchart showing the sequence of document processing of the Web browser 400 according to this embodiment. Respective processes shown in FIG. 9 can be implemented when the CPU 201 of the MFP 101 executes control programs. In step S901, the Web browser 400 waits for an input operation from the user. The Web browser 400 checks in step S902 whether or not the input operation from the user is detected. For example, the operation instruction input unit 401 checks whether or not the user has made an input operation of a server address which permits document processing. If it is determined in step S902 that the input operation of the server address has been made, input processing of the server address is executed in step S911.

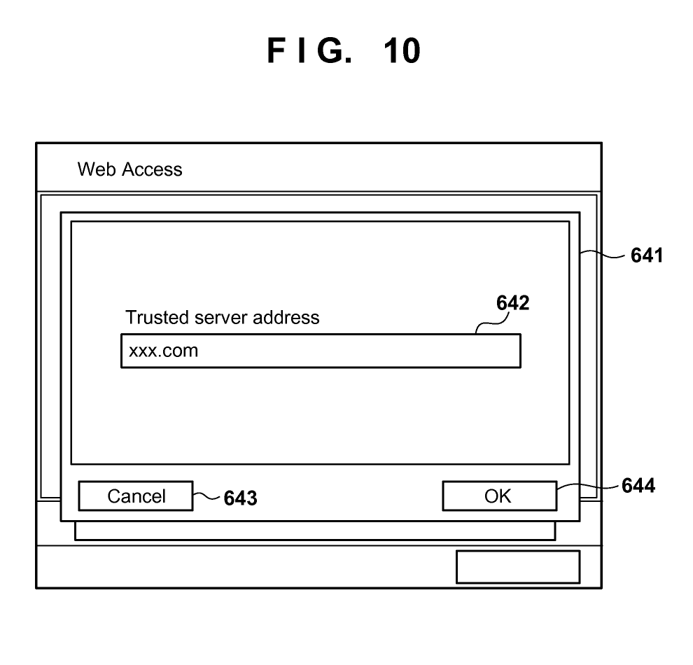

FIG. 10 is a view showing an example of a server address input instruction screen, which is displayed by the saving processing unit 410 of the Web browser 400 on the operation display unit 211 in step S911. The Web browser 400 displays a server address input dialog 641 to prompt the user to designate an address of a Web server. The user can input an address of a Web server via an address input field 642. In this embodiment, only when a document is received from a Web server having an address that matches the address input to the address input field 642, document processing is executed. The user can cancel the substance input to the address input field 642 by pressing a cancel button 643. On the other hand, the user settles a setting of an address input to the address input field 642 by pressing an OK button 644.

In step S911, the address saving unit 408 displays the server address input dialog 641 on the operation display unit 211, and saves the server address information input by the user in the address database 411. After step S911, the process returns to step S901. If it is determined in step S902 that no server address input instruction is detected, the Web browser 400 checks in step S903 whether or not the user inputs a content acquisition instruction. This process is the same as that of step S802 of the first embodiment. Processes in steps S904 to S908 in FIG. 9 are the same as those in steps S803 to S807 of the first embodiment.

In step S909, the processing execution unit 406 acquires an address of the Web server 102, from which the content is received in step S905, from the processing instruction analysis unit 405. Also, the processing execution unit 406 acquires the address saved in the address database 411. Then, the processing execution unit 406 checks whether or not the address of the Web server 102 from which the document is received matches that saved in the address database 411. In this case, if it is determined that the address of the Web server 102 from which the document is received matches that saved in the address database 411, designated document processing is executed in step S910. Step S910 is the same as the process of step S808 of the first embodiment. On the other hand, if it is determined in step S909 that the address of the Web server 102 does not match that saved in the address database 411, the document processing inquiry dialog 631 is displayed for the user in step S913. Step S913 is the same as the process of step S810 of the first embodiment. If it is determined in step S906 that the type of the received content is that which cannot be processed by the MFP 101, the content analysis unit 403 analyzes the substance of the content to draw and generate a screen in step S912. Step S912 is the same as the process of step S809 of the first embodiment.

As described above, according to the second embodiment, designated document processing is executed only for a document which is received from a Web server having an address which matches the predetermined address. Thus, documents in large quantities can be prevented from being unwantedly printed by a document processing instruction received from an ill-intended Web server, thus maintaining high security.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-269395, filed Dec. 8, 2011, which is hereby incorporated by reference herein in its entirety.

What is claimed is:

1. An information processing apparatus comprising:
a request unit configured to send a request of a document to a Web server;
a receiving unit configured to receive the document sent from the Web server in response to the request of said request unit;
a determination unit configured to determine processing to be executed for the document received by said receiving unit based on a query parameter designated when said request unit sends the request; and
a processing unit configured to execute the processing determined by said determination unit for the document received by said receiving unit.

2. The apparatus according to claim 1, further comprising:
a Web browser configured to receive screen information from the Web server, and to display an operation screen to accept selection of processing by a user,
wherein the request unit sends the request after the selection of processing is accepted by the user.

3. The apparatus according to claim 2, wherein the query parameter is included in the screen information received from the Web server.

4. The apparatus according to claim 1, further comprising:
an accepting unit configured to accept, in a case where a query parameter is not designated when said request unit sends the request, selection of processing to be executed for the document received by said receiving unit from a user after said request unit sends the request.

5. The apparatus according to claim 4, wherein in a case where the processing determined by said determination unit is not allowed to be executed, said accepting unit accepts selection of processing to be executed for the document received by said receiving unit from the user after said request unit sends the request.

6. The apparatus according to claim 1, wherein the processing to be executed by said processing unit includes processing for printing the document received by said receiving unit.

7. The apparatus according to claim 1, wherein the processing to be executed by said processing unit includes processing for saving the document received by said receiving unit in a storage unit in said information processing apparatus.

8. The apparatus according to claim 1, further comprising:
a checking unit configured to check whether or not the Web server is a Web server which is designated in advance,
wherein when it is determined that the Web server is the Web server which is designated in advance, said processing unit executes the processing determined by said determination unit for the document received by said receiving unit.

9. An information processing method comprising:
sending a request of a document to a Web server;
receiving the document sent from the Web server in response to the request;
determining processing to be executed for the document received based on a query parameter designated when the request is sent; and
executing the determined processing for the received document.

10. The method according to claim 9, further comprising:
a Web browser configured to receive screen information from the Web server, and to display an operation screen to accept selection of processing by a user
wherein the request is sent to the Web server after the selection of processing is accepted by the user.

11. The method according to claim 10, wherein the query parameter is included in the screen information received from the Web server.

12. The method according to claim 9, further comprising:
accepting, when a query parameter is not designated when the request is sent, selection of processing to be executed for the document received from a user after the request is sent.

13. The method according to claim 12, wherein in the accepting, when the determined processing is not allowed to be executed, selection of processing to be executed for the document to be received is accepted from the user after the request is sent.

14. The method according to claim 9, wherein the processing to be executed includes processing for printing the received document.

15. The method according to claim 9, wherein the processing to be executed includes processing for saving the received document in a storage unit in an information processing apparatus.

16. The method according to claim 9, further comprising checking whether or not the Web server is a Web server which is designated in advance,
wherein when it is determined that the Web server is the Web server, which is designated in advance, the determined processing is executed for the received document.

17. A computer-readable storage medium storing a program for controlling a computer to:
send a request of a document to a Web server;
receive the document sent from the Web server in response to the request;
determine processing to be executed for the document received based on a query parameter designated when the request is sent; and
execute the determined processing for the received document.
